(19) United States
(12) Patent Application Publication
(10) Pub. No.: US 2006/0139302 A1
(43) Pub. Date: Jun. 29, 2006

(54) Method for driving an active matrix liquid crystal display

(75) Inventors: Long Kuan Chen, Miao-Li (TW); Eddy G. Chen, Miao-Li (TW); Chih-sheng Chang, Miao-Li (TW); Sz Hsiao Chen, Miao-Li (TW); Tsau Hua Hsieh, Miao-Li (TW); Jia-Pang Pang, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/316,784

(22) Filed: Dec. 22, 2005

(30) Foreign Application Priority Data
Dec. 24, 2004 (TW) 93140428

(51) Int. Cl. G09G 3/36

(52) U.S. Cl. 345/102

(57) ABSTRACT

A method for driving an active matrix liquid crystal display (LCD) (200) includes: dividing a frame time into a first period and a second period; defining a gradation voltage that makes the light transmission of a pixel unit accumulated in the first period correspond to image data of an external circuit; defining a black-inserting voltage which corresponds with a black image; applying the gradation voltage to pixel electrodes (203) of pixel units of the LCD when the gate lines (201) are scanned by a gate driver (210) of the LCD in the first period; applying the black-inserting voltage to the pixel electrodes of the pixel units when the gate lines are scanned by the gate driver in the second period; and turning off a backlight of the LCD in the second period.

### FIELD OF THE INVENTION

The present invention relates to liquid crystal displays (LCDs), and particular to an active matrix type LCD which is suitable for motion picture display.

### BACKGROUND

Because LCD devices have the advantages of portability, low power consumption, and low radiation, they have been widely used in various portable information products such as notebooks, personal digital assistants (PDAs), video cameras, and the like. Furthermore, LCD devices are considered by many to have the potential to completely replace CRT (cathode ray tube) monitors and televisions.

FIG. 3 is an abbreviated circuit diagram of a conventional active matrix LCD. The active matrix LCD 100 includes a glass first substrate (not shown), a glass second substrate (not shown) facing the first substrate, a liquid crystal layer (not shown) sandwiched between the first substrate and the second substrate, a gate driver 110, a data driver 120, and a backlight (not shown).

The first substrate includes a number n (where n is a natural number) of gate lines 101 that are parallel to each other and that each extend along a first direction, and a number m (where m is also a natural number) of data lines 102 that are parallel to each other and that each extend along a second direction orthogonal to the first direction. The first substrate also includes a plurality of thin film transistors (TFTs) 104 that function as switching elements. The first substrate further includes a plurality of pixel electrodes 103 formed on a surface thereof facing the second substrate. Each TFT 104 is provided in the vicinity of a respective point of intersection of the gate lines 101 and the data lines 102.

Each TFT 104 includes a gate electrode 1040, a source electrode 1041, and a drain electrode 1042. The gate electrode 1040 of each TFT 104 is connected to the corresponding gate line 101. The source electrode 1041 of each TFT 104 is connected to the corresponding data line 102. The drain electrode 1042 of each TFT 104 is connected to a corresponding pixel electrode 103.

The second substrate includes a plurality of common electrodes 105 opposite to the pixel electrodes 103. In particular, the common electrodes 105 are formed on a surface of the second substrate facing the first substrate, and are made from a transparent material such as ITO (Indium-Tin Oxide) or the like. A pixel electrode 103, a common electrode 105 facing the pixel electrode 103, and liquid crystal molecules of the liquid crystal layer sandwiched between the two electrodes 103, 105 cooperatively define a single pixel unit.

The gate lines 101 are connected to the gate driver 110. The data lines 102 are connected to the data driver 120. The backlight (not shown) functions as a light source for the active matrix LCD 100. The backlight is always turned on when the active matrix LCD 100 is in an operational state.

FIG. 4 includes three timing charts illustrating operation of the active matrix LCD 100. Chart (a) is a voltage waveform, showing a voltage of the gate electrode 1040 of a TFT 104 varying over time. Chart (b) is a voltage waveform, showing a voltage of the source electrode 1041 of the TFT 104 varying over time. Chart (c) is a voltage waveform, showing a voltage of the drain electrode 1042 of the TFT 104 varying over time.

Referring to FIGS. 3 and 4, in one frame display, the gate driver 110 sequentially provides scanning pulses “Vg” to the gate lines 101, and activates the TFTs 104 respectively connected to the gate lines 101. When the gate lines 101 are thus scanned, the data driver 120 outputs a gradation voltage “Vd” corresponding with image data of an external circuit to the data lines 102. Then the gradation voltage Vd is applied to the pixel electrodes 103 via the activated TFTs 104, and the pixel electrodes 103 maintain the potentials as “Vp1” (as shown in chart (c)) until the next scanning pulse Vg is applied to the TFTs 104 in the next frame display. The potentials Vcom of the common electrodes 105 are set at a uniform potential. The gradation voltage Vd written to the pixel electrodes 103 is used to control the amount of light transmission of the corresponding pixel units and consequently provide an image display for the active matrix LCD 100. In the next frame display, the pixel electrodes 103 maintain the potentials as “Vp2” (as shown in chart (c)).

In FIG. 4, the gradation voltage Vd is a signal whose strength varies in accordance with each piece of image data, whereas the signal of common voltage Vcom has a constant value that does not vary at all.

If motion picture display is conducted on the active matrix LCD 100, problems of poor image quality may occur. For example, the residual image phenomenon may occur because the response speed of the liquid crystal molecules is too slow. When a gradation voltage variation occurs, the liquid crystal molecules are unable to track the gradation voltage variation within a single frame period and produce a cumulative response during several frame periods. Consequently, considerable research is being conducted with a view to developing various fast response liquid crystal materials as a way of overcoming this problem.

Further, the aforementioned problems such as the residual image phenomenon are not caused solely by the response speed of the liquid crystal molecules. For example, when the displayed image is changed in each frame period (the period that the gate driver 110 sequentially completes scanning the gate lines 101 to display the motion picture), the displayed image of one frame period remains in a viewer's eyes as an afterimage, and this afterimage overlaps with the viewer's perception of the displayed image of the next frame period. This means that from the viewpoint of a user, the image quality of the displayed image is impaired.

It is desired to provide an active matrix LCD that can overcome the above-described deficiencies.

### SUMMARY

A method for driving an active matrix liquid crystal display (LCD) includes: dividing a frame time into a first period and a second period; defining a gradation voltage that makes the light transmission of a pixel unit accumulated in the first period correspond to image data of an external circuit; defining a black-inserting voltage which corresponds with a black image; applying the gradation voltage to pixel electrodes of pixel units of the LCD when the gate lines are scanned by a gate driver of the LCD in the first period; applying the black-inserting voltage to the pixel electrodes of the pixel units when the gate lines are scanned by the gate driver in the second period; and turning off a backlight of the LCD in the second period.

Advantages and novel features of the method will become more apparent from the following detailed description when taken in conjunction with the accompanying drawings, in which:

### BRIEF DESCRIPTION OF THE DRAWINGS

FIG. 1 is an abbreviated circuit diagram of an active matrix LCD according to an exemplary embodiment of the present invention;

FIG. 2 includes five timing charts illustrating operation of the active matrix LCD of FIG. 1;

FIG. 3 is an abbreviated circuit diagram of a conventional active matrix LCD; and

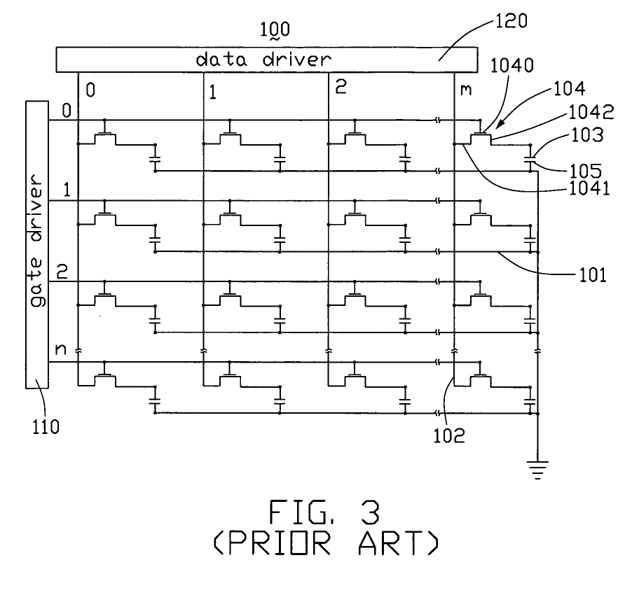

FIG. 4 includes three timing charts illustrating operation of the active matrix LCD of FIG. 3.

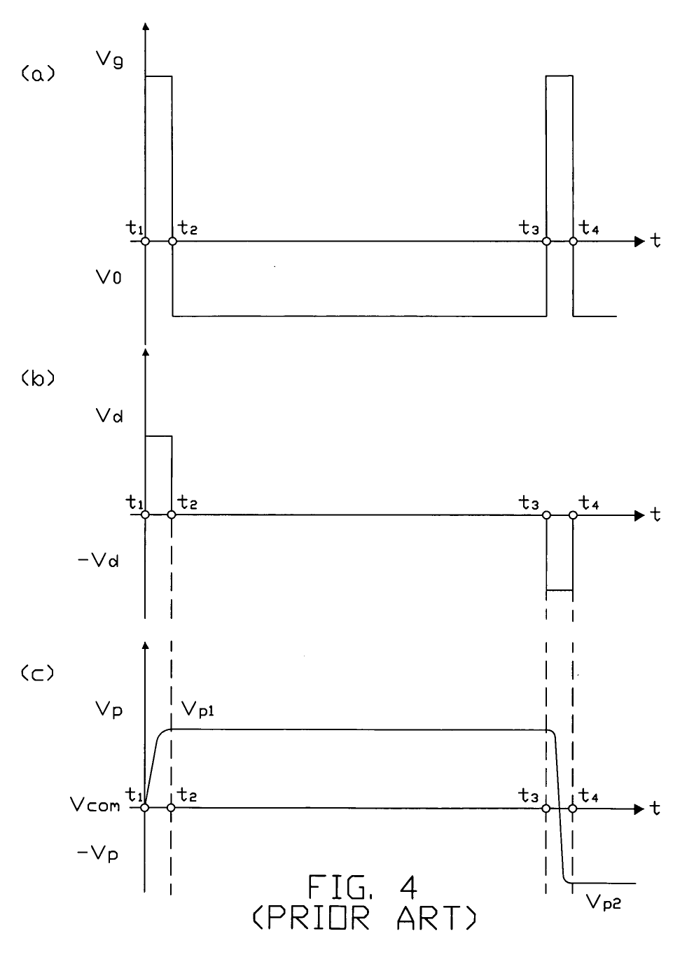

### DETAILED DESCRIPTION OF PREFERRED EMBODIMENTS

Reference will now be made to the drawings to describe the present invention in detail.

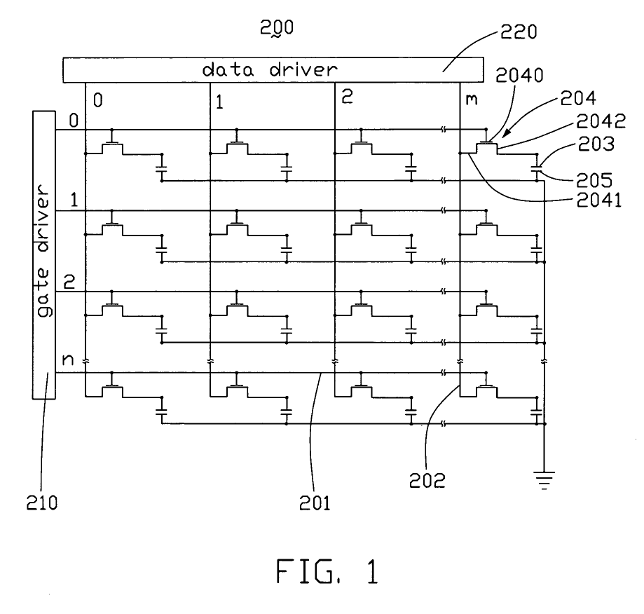

FIG. 1 is an abbreviated circuit diagram of an active matrix LCD according to an exemplary embodiment of the present invention. The active matrix LCD 200 includes a glass first substrate (not shown), a glass second substrate (not shown) facing the first substrate, a liquid crystal layer (not shown) sandwiched between the first substrate and the second substrate, a gate driver 210, a data driver 220, and a backlight (not shown).

The first substrate includes a number n (where n is a natural number) of gate lines 201 that are parallel to each other and that each extend along a first direction, and a number m (where m is also a natural number) of data lines 202 that are parallel to each other and that each extend along a second direction orthogonal to the first direction. The first substrate also includes a plurality of thin film transistors (TFTs) 204 that function as switching elements. The first substrate further includes a plurality of pixel electrodes 203 formed on a surface thereof facing the second substrate. Each TFT 204 is provided in the vicinity of a respective point of intersection of the gate lines 201 and the data lines 202.

Each TFT 204 includes a gate electrode 2040, a source electrode 2041, and a drain electrode 2042. The gate electrode 2040 of each TFT 204 is connected to the corresponding gate line 201. The source electrode 2041 of each TFT 204 is connected to the corresponding data line 202. The drain electrode 2042 of each TFT 204 is connected to a corresponding pixel electrode 203.

The second substrate includes a plurality of common electrodes 205 opposite to the pixel electrodes 203. In particular, the common electrodes 205 are formed on a surface of the second substrate facing the first substrate, and are made from a transparent material such as ITO (Indium-Tin Oxide) or the like. A pixel electrode 203, a common electrode 205 facing the pixel electrode 203, and liquid crystal molecules of the liquid crystal layer sandwiched between the two electrodes 203, 205 cooperatively define a single pixel unit.

The gate lines 201 are connected to the gate driver 210. The data lines 202 are connected to the data driver 220. The backlight functions as a light source for the active matrix LCD 200. The backlight typically uses an LED (light emitting diode) or a CCFL (cold cathode fluorescent lamp) as a light source. Generally, when the active matrix LCD 200 displays an image at a frequency such as 60 Hz, a frame time is equal to 16.7 milliseconds.

A method for driving the active matrix LCD 200 includes: dividing a frame time into a first period and a second period; defining a gradation voltage that makes the light transmission of a pixel unit accumulated in the first period correspond to image data of an external circuit; defining a black-inserting voltage corresponding with a black image; applying the gradation voltage to the pixel electrodes 203 of the pixel units when the gate lines 201 are scanned by the gate driver 210 in the first period; applying the black-inserting voltage to the pixel electrodes 203 of the pixel units when the gate lines 201 are scanned by the gate driver 210 in the second period; and turning off the backlight in the second period.

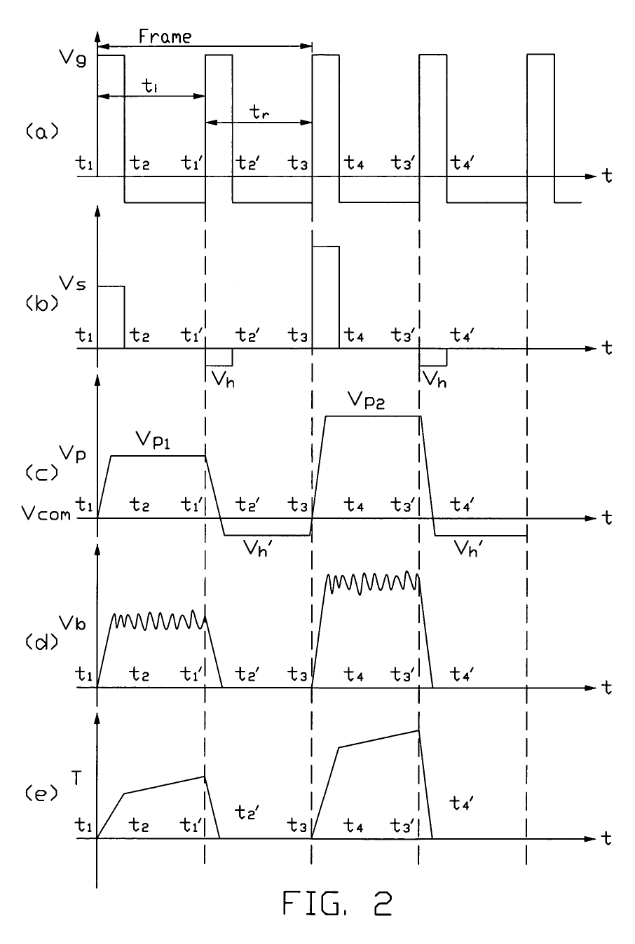

FIG. 2 includes five timing charts illustrating operation of the active matrix LCD 200. Chart (a) is a voltage waveform, showing a voltage of the gate electrode 2040 of a TFT 204 varying over time. Chart (b) is a voltage waveform, showing a voltage of the source electrode 2041 of the TFT 204 varying over time. Chart (c) is a voltage waveform, showing a voltage of the drain electrode 2042 of the TFT 204 varying over time. Chart (d) is a voltage waveform, showing a voltage applied to the backlight. Chart (e) shows light transmission of the corresponding pixel unit varying over time.

Referring to FIGS. 1 and 2, the operation of the active matrix LCD 200 is as follows. In the first period of a first frame time, as shown in chart (a), the gate driver 210 sequentially provides scanning pulses “Vg” to the gate lines 201, and activates the TFTs 204 respectively connected to the gate lines 201. When the gate lines 201 are thus scanned, as shown in chart (b), the data driver 220 outputs the defined gradation voltage “Vs” to the data lines 202. Then the defined gradation voltage Vs is applied to the pixel electrodes 203 via the activated TFTs 204, and the pixel electrodes 203 maintain the potentials as “Vp1” (as shown in chart (c)) until the second period of the first frame time.

In the second period of the first frame time, as shown in chart (a), the gate driver 210 sequentially provides scanning pulses Vg to the gate lines 201 again, and activates the TFTs 204 respectively connected to the gate lines 201. When the gate lines 201 are thus scanned, as show in chart (b), the data driver 220 outputs the defined black-inserting voltage “Vh” to the data lines 202. Then the black-inserting voltage Vh is applied to the pixel electrodes 203 via the activated TFTs 204, and the pixel electrodes 203 maintain the potentials as Vh′ (as shown in chart (c)) until the second frame time. Furthermore, in order to reduce the light transmission of the pixel units in the second period of each frame time, a driving voltage “Vb” is applied to the backlight by a backlight driving circuit (not shown), whereby the backlight is turned off in the second period of each frame time (as shown in chart (d)).

In the second frame time, the operation of the active matrix LCD 200 is the same as that in the first frame time, except that the pixel electrodes 203 maintain the potentials as “Vp2” (as shown in chart (c)).

In each frame time, the potentials Vcom of the common electrodes 205 are set at a uniform potential. The defined gradation voltage Vs written to the pixel electrodes 203 is used to control the amount of light transmission of the corresponding pixel units and consequently provide an image display for the active matrix LCD 200. The black-inserting voltage Vh written to the pixel electrodes 203 is used to control the amount of light transmission of the corresponding pixel units and consequently provide a black image display for the active matrix LCD 200. The light transmission “T” of the pixel unit corresponding to each TFT 204 of the active matrix LCD 200 is shown in chart (e).

Unlike with the method for driving the above-described conventional active matrix LCD 100, in the method for driving the active matrix LCD 200, a frame time is divided into a first period “tᵢ” and a second period “tᵣ”. The data driver 210 provides the defined gradation voltage Vs to the pixel electrodes 203 in the first period tᵢ. The data driver 220 provides the black-inserting voltage Vh to the pixel electrodes 203 in the second period tr. The backlight is turned off in the second period tᵣ. With this mode of operation, a viewer's eyes perceive the black image during the second period tᵣ, and any afterimage of the image displayed in the first period tᵢ that would otherwise exist in the viewer's eyes is lost. Accordingly, there is no afterimage that can overlap with the viewer's perception of the displayed image of the next frame time. This means that from the viewpoint of a user, the image quality of the displayed image is unimpaired. In order to improve the quality of the display image on the active matrix LCD 200, the first period tᵢ can be set to be longer than, equal to, or shorter than the second period tᵣ.

In alternative embodiments, for example, a black-inserting voltage corresponding with a predetermined desired image can be defined. In such case, a user views the desired image instead of a black image.

It is to be further understood that even though numerous characteristics and advantages of preferred embodiments have been set out in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A method for driving an active matrix liquid crystal display (LCD), comprising:
dividing a frame time into a first period and a second period;
defining a gradation voltage that makes the light transmission of a pixel unit accumulated in the first period correspond to image data of an external circuit;
defining a black-inserting voltage which corresponds with a black image;
applying the gradation voltage to pixel electrodes of pixel units of the LCD when gate lines of the LCD are scanned by a gate driver of the LCD in the first period;
applying the black-inserting voltage to the pixel electrodes of the pixel units when the gate lines are scanned by the gate driver in the second period; and
turning off a backlight of the LCD in the second period.

2. The method as claimed in claim 1, wherein the backlight is a CCFL (cold cathode fluorescent lamp).

3. The method as claimed in claim 1, wherein the backlight is an LED (light emitting diode).

4. The method as claimed in claim 1, wherein the frame time is equal to 16.7 milliseconds.

5. The method as claimed in claim 1, wherein the first period is equal to the second period.

6. The method as claimed in claim 1, wherein the first period is longer than the second period.

7. The method as claimed in claim 1, wherein the second period is longer than the first period.
